(19) United States
(12) Patent Application Publication
(10) Pub. No.: US 2021/0308820 A1
(43) Pub. Date: Oct. 7, 2021

(54) METHOD FOR MACHINING THE RUNNING SURFACE OF A RAIL

(71) Applicant: MATE GmbH, Kirccham bei Vorchdorf (AT)

(72) Inventors: Wilhelm Kubin, Steyrermuehl (AT); Werner Daves, Leoben (AT); Werner Ecker, Leoben (AT)

(73) Assignee: MATE GmbH, Kirccham bei Vorchdorf (AT)

(21) Appl. No.: 17/266,179

(22) PCT Filed: Apr. 6, 2019
(86) PCT No.: PCT/AT2019/060252

§ 371 Date: Feb. 5, 2021

(30) Foreign Application Priority Data
Aug. 7, 2018 (AT) A 50675/2018

(51) Int. Cl. B24B 19/00; B23P 9/02; E01B 31/13

(52) U.S. Cl. CPC B24B 19/004; E01B 31/13; B23P 9/02

(57) ABSTRACT

The system described herein relates to machining the running surface of a rail by means of at least one rotating, chip-removing shaping tool which can be moved along the rail and can be pressed at least against its running surface. In order to create advantageous design conditions, it is proposed that after the machining with the chip-removing shaping tool at least one rolling body which is adapted to the shape-machined rail surface is rolled over the rail, with cold deformation of the running surface of the rail, in order to level out unevenness of the running surface of the rail.

### FIELD OF THE INVENTION

The system described herein relates to machining the running surface of a rail.

### DESCRIPTION OF THE PRIOR ART

Rails of rail vehicle tracks are subject to wear caused by contact forces between rails and the wheels of the rail vehicle rolling on them. The undesired changes in the rail cross section caused by wear are subjected to a reprofiling process at regular intervals or as required by the circumstances in order to extend the service life. Preventive machining is also possible. Rail unevenness in the area of the rail head being driven over is divided into longitudinal waves (along the rail axis), corrugations (transverse to the rail axis) and finally roughness. Longitudinal waves are usually caused by the running operation. Corrugations are also caused by milling the rail head, for example. Roughness occurs especially during grinding of the rail head. Reprofiling of the rail head is mainly carried out with machining processes such as grinding, planing, rotary planing or milling, wherein these machining processes are either carried out on removed rails or can nowadays usually be carried out in the laid track by means of rail-guided machining vehicles (EP 2 638 209 A1).

A method and a device for reprofiling a rail is known from WO 02/06587 A1, for example. In it, a rail-guided machining vehicle is disclosed, with which the running surface of a rail, which essentially comprises the running surface and the running edge, is brought back to or approximated to the desired profile by means of peripheral milling and, if necessary, by a grinding process. With such a method and such a machining vehicle, the desired profile of rails can be restored in a short time in a rational way. Up to now, however, their use has only been possible on continuous track sections, whereas on track sections with rail interruptions, such as in the area of switches and crossings, reprofiling is often carried out with hand-held processing tools or smaller special devices. For this reason, EP 2 638 209 A1 was proposed as a method and a device for reprofiling rails, with which rational and defined reprofiling is also possible in the area of switches and track crossings.

It has been shown (Sadeghi, J., Hasheminezhad, A., Correlation between rolling noise generation and rail roughness of tangent tracks and curbes in time and frequency domains. Applied Acoustics 2016; 107: 10-18) that a periodic roughness on a rail surface, as it occurs after reprofiling the rail by milling or possibly also by grinding, leads to a significant increase in sound pressure when the rail is rolled over by a rail vehicle wheel, which is a high acoustic burden on the environment during rollover.

Also as a result of rail operation, local periodic irregularities of the running surface occur on the rail surfaces forming the running surfaces. These irregularities cause vibrations and structure-borne noise when the wheels of the rail vehicle roll, which leads to noise pollution of the environment and noise and vibration nuisance for the passengers. One possibility for the early detection of unevenness in the running surface is known from EP 1 612 551 A1. In order to determine the roughness of freshly ground rails and/or rail areas, twisted current test probes are guided over areas of rail segments and the measurement signals are evaluated depending on the location.

Accordingly, it is desirable that a periodic roughness on a rail surface, such as occurs, for example, after reprofiling the rail by milling or, optionally, grinding, can be avoided by simple means.

### SUMMARY OF THE INVENTION

According to the system described herein, after machining with the chip-removing shaping tool, at least one rolling body which is adapted to the shape-machined rail surface is rolled over the rail, with cold deformation of the running surface of the rail, in order to level out unevenness in the running surface of the rail.

The rolling body acting as a roller rolls with a shell of the rolling body on the running surface of the rail, wherein the generatrix of the shell surface rolling on the running surface about an axis corresponds to the cross-section of a shape-machined, i.e. already reprofiled, rail surface. In the system described herein, one or more rolling bodies, adapted to the reprofiled running surface, are rolled over the rail with high contact pressure within the framework of rail maintenance following the rail reprofiling process, for example by milling, rotary planing and/or grinding, in order to level out the unevenness, in particular longitudinal waves or corrugations, and/or to modify the roughness of the surface. For the system described herein, the finishing with the rolling body is not abrasive, but takes place under cold forming, i.e. without material removal. The system described herein therefore works without sparks or residues and without heat input into the rail which affects the rail strength. Due to the high contact pressure, a high pressure is exerted on the rail with a correspondingly small contact area with the rail, which causes the desired cold deformation. In particular, corrugations are to be smoothed in order to reduce periodic roughness on the rail surface and to avoid or noticeably reduce noise emissions as the noise emissions occur when a rail vehicle wheel rolls over the rail.

The rolling body is rolled over the rail under cold deformation of at least the running surface of the rail, but the running edge can also be machined according to the system described herein.

If the rolling body is rolled over the rail with a leading or trailing slip of between 0.001 and 20%, even better results may be achieved with the system described herein. The rolling body thus rotates faster or slower, as required, than the rolling body would with slip-free rolling on the rail.

It is recommended if the rolling body is made of a higher-strength material than the rail and is rolled over the rail with a predetermined, particularly finely structured surface structure, wherein the surface structure is plastically pressed into the rail during the rollover process. The rolling body has the desired finely structured surface structure on the surface of the shell that rolls on the rail, which is rolled over the rail with or without slip.

This surface structure is understood to be a surface with defined hills and valleys, wherein the hills penetrating into the rail surface can generate local peak pressures that favour a plastic deformation of the running surface of the rail. Thus longitudinal waves or corrugations can be at least partially levelled.

In order to achieve the necessary pressure between rolling body and rail with reasonable effort it is suggested that the rolling body is rolled over the rail with a nominal contact pressure of 0.8 to 2, especially 1.2 to 1.75 GPa. The nominal contact pressure is the contact pressure between an (idealized) smooth rolling body and an (idealized) smooth rail.

The measures described above promote a targeted plasticization of the rail close to the surface, which is conducive to a leveling of the waves or corrugations. The aim is to smooth out the unevenness in the running surface of the rail, which is seen as the cause of the excitation of sound-generating vibrations in the wheel-rail system, to such an extent that this excitation is prevented.

At least two rolling bodies may be rolled over the rail one after the other with cold deformation of the running surface of the rail, wherein it is particularly advantageous if the rolling bodies are rolled over the rail with different slip and/or different surface structure and/or different contact pressure.

Similarly, the shaping tool and the rolling tool can also be mounted on a stationary machining device and in this case the rail may be moved at a feed rate along the shaping tool and the rolling tool for machining at least the running surface of a rail.

A device according to the system described herein for machining at least the running surface of a rail includes a rail-guided machining vehicle or a stationary machining device, wherein the machining vehicle or machining device is designed in such a way that shaping tool and rolling tool on the one hand and the rail on the other hand are movable relative to one another, wherein the at least one rotating, chip-removing shaping tool which can be pressed against the running surface of the rail machines the rail. A rolling body adapted to the shape-machined rail surface is arranged downstream of the chip-removing shaping tool in its working direction, which rolling body can be moved along the rail with the machining vehicle for the purpose of leveling unevenness of the running surface of the rail, with cold deformation of the running surface of the rail, and can be pressed against the running surface of the rail by means of an actuating drive.

A device for carrying out the method according to the system described herein is shown in the figure description.

### BRIEF DESCRIPTION OF THE DRAWINGS

In the drawings, the subject matter of the system described herein is shown schematically, for example, wherein:

FIG. 1 shows a machining vehicle with a device according to the system described herein in side view,

FIG. 2 shows an enlarged side view of a detail of the device from FIG. 1 in side view,

FIG. 3 shows a rolling body rolling on a rail in inclined view,

FIG. 4 shows a diagram showing the leveling of longitudinal waves caused by the milling cutter and

FIG. 5 a diagram showing the leveling of cutter-related transverse waves (corrugations).

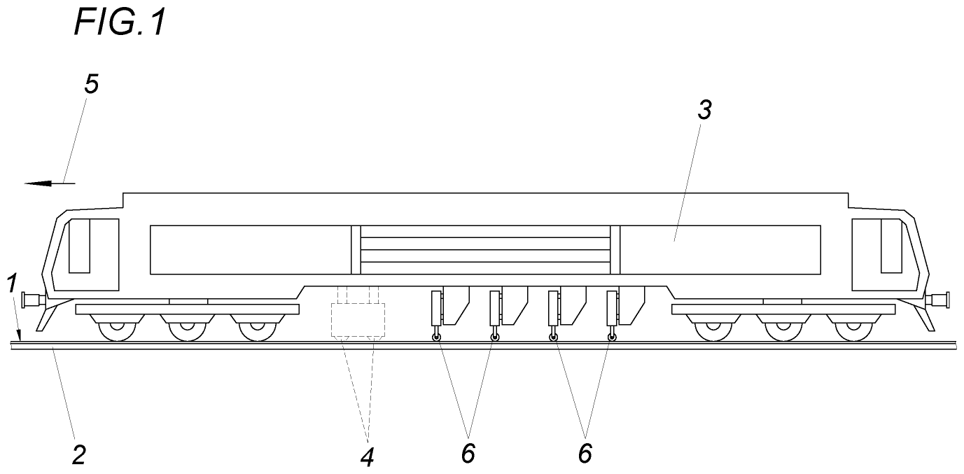

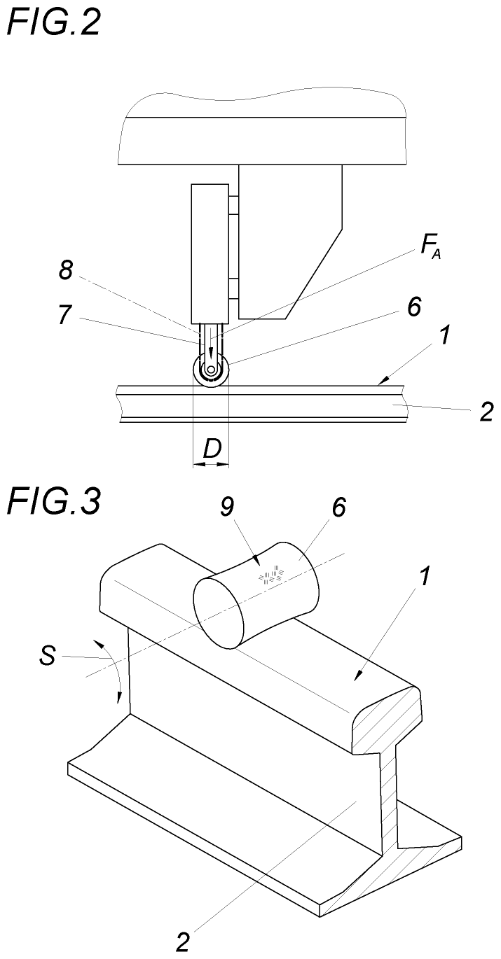

### DESCRIPTION OF THE PREFERRED EMBODIMENTS

The device for machining the running surface 1 of a rail 2 with a rail-guided machining vehicle 3 includes at least one rotating, chip-removing shaping tool 4 which can be moved along the rail and pressed against its running surface 1. A rolling body 6 adapted to the shape-machined rail surface is arranged downstream of the shaping tool 4 in a working direction 5 extending in the longitudinal direction of the rail. The rolling body 6 may be moved along the rail 2 with the machining vehicle 3 for the purpose of leveling unevenness of the running surface 2 of the rail, with cold deformation of at least the running surface, in particular the shape-machined rail surface, of the rail 2, and can be pressed with an actuating drive 7 against the running surface 1 of the rail with a defined setting force F_{A}. The machining vehicle 3 may, if necessary, consist of two or more carriages, which may operate independently, for example at least one for the shaping tool 4 and at least one for the rolling bodies 6.

The rolling body 6 is equipped with a rotary drive 8, which rolls the rolling body over rail 2 with a leading or trailing slip s of between 0.001 and 20%. The rotary drive 8 can also act as a brake drive. The rolling body 6 is made of a higher-strength material than the rail and has a predetermined, particularly finely structured surface structure 9 with a roughness depth of <10 μm, particularly <1 μm.

The rolling body, for example, has a diameter D of less than 50 mm and is pressed against the running surface of the rail by the actuating drive 7 with a nominal contact pressure of 0.8 to 2, in particular of 1.2 to 1.75 GPa. The nominal contact pressure prevails in the contact area between rail and rolling body.

Numerical investigations have shown that it is possible to influence the surface condition in the desired sense after rolling over the previously abrasively machined rail with specifically selected contact parameters (rolling body diameter, contact pressure and, depending on geometry and load, between 0.001 and 20% with a leading or trailing slip). A defined rollover of the rail with the rolling body leads to a leveling of the roughness peaks.

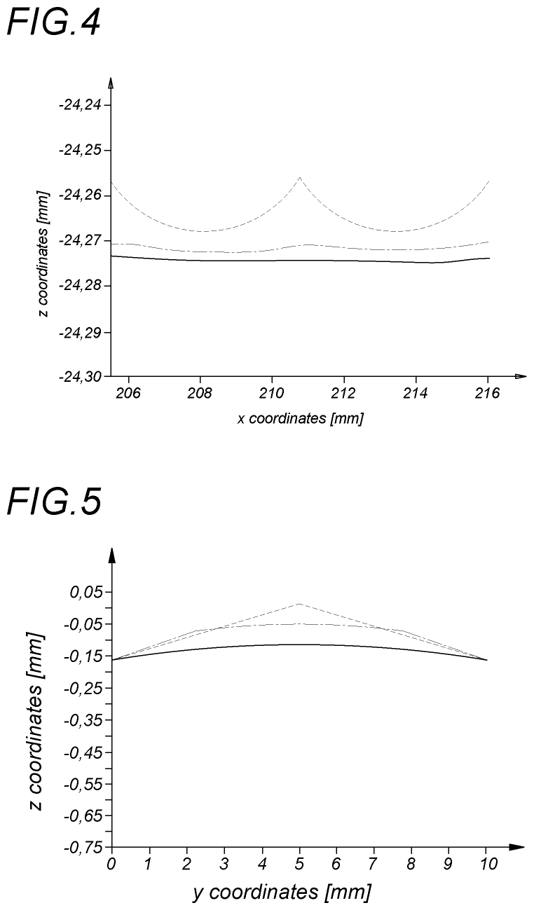

FIG. 4 shows a calculation of the leveling of longitudinal wave peaks (normal to the longitudinal direction of the rail) by plotting the surface coordinates before and after several simulated rollovers with a contact pressure of 1.25 GPa and a braking slip of 1.5%. The rail extends in the direction of the x-coordinate. The z-coordinate corresponds to a rail vertical axis. For a wave peak height of 12 μm one rollover cycle is sufficient under the given conditions to level the wave. In particular, a leveling of longitudinal waves when rolling over with a smooth rolling body is shown. The contact pressure corresponds to 1.25 GPa, with a lagging, i.e. braking, slip of 1.5%. The rail steel has a quality of R260. One rollover cycle is sufficient for sufficient leveling.

FIG. 5 shows the leveling of transverse waves (corrugations). The y-coordinate corresponds to a rail transverse axis. A leveling of transverse waves when rolling over with a smooth rolling body is shown for two exemplary cases. Once with a contact pressure of 1.52 GPa and a second time with a contact pressure of 1.69 GPa, with a lagging slip of 1.5% and a rail steel of quality R260. With the aforementioned selected parameters, a transverse shaft can be leveled substantially with only one overrolling and comparable in size to the leveling by grinding directly after rail milling.

The system described herein is not restricted to the described embodiments. It may be varied within the scope of the claims, taking into account the knowledge of the relevant person skilled in the art. Other embodiments of the system described herein will be apparent to those skilled in the art from a consideration of the specification and/or an attempt to put into practice the system described herein. It is intended that the specification and examples be considered as illustrative only, with the true scope and spirit of the invention being indicated by the following claims.

1. Method for machining the running surface of a rail with the aid of at least one rotating, chip-removing shaping tool, comprising:
moving the chip-removing shaping tool along the rail;
pressing the chip-removing shaping tool against the running surface of the rail; and
after moving and pressing with the chip-removing shaping tool, rolling at least one rolling body over the rail, with cold deformation of the running surface of the rail, in order to level out unevenness in the running surface of the rail.

2. Method according to claim 1, wherein the rolling body is rolled over the rail with a leading or trailing slip of between 0.001 and 20%.

3. Method according to claim 1, wherein the rolling body consisting of a higher-strength material than the rail is rolled over the rail with a predetermined finely structured surface structure and wherein the surface structure is plastically pressed into the rail in the rollover process.

4. Method according to claim 1, wherein the rolling body is rolled over the rail with a nominal contact pressure of 0.8 to 2.

5. Method according to claim 1, wherein at least two rolling bodies are rolled over the rail one after the other with cold deformation of the running surface of the rail.

6. Method according to claim 5, wherein the rolling bodies are rolled over the rail with different slip and/or different surface structure and/or different contact pressure.

7. Device for machining the running surface of a rail with a rail-guided machining vehicle comprising:
at least one rotating, chip-removing shaping tool which can be moved along the rail and can be pressed against the running surface thereof to provide a shape-machined rail surface; and
a first rolling body adapted to the shape-machined rail surface arranged downstream of the chip-removing shaping tool in a working direction (5), wherein the first rolling body is moveable along the rail with the machining vehicle for leveling unevenness of a running surface of the rail, with cold deformation of the running surface of the rail, the first rolling body being pressed against the running surface of the rail by an actuating drive.

8. Device according to claim 7, wherein the first rolling body is equipped with a rotary drive and/or brake drive which rolls the first rolling body over the rail with a leading or trailing slip of between 0.001 and 20%.

9. Device according to claim 7, wherein the first rolling body consists of a higher-strength material than the rail and has a predetermined finely structured surface structure with a roughness depth of <10 μm.

10. Device according to claim 7, wherein the first rolling body is pressed with the actuating drive against the running surface of the rail with a nominal contact pressure of 0.8 to 2.

11. Method according to claim 4, wherein the rolling body is rolled over the rail with a nominal contact pressure of 1.2 to 1.75 GPa.

12. Device according to claim 9, wherein the surface structure has a roughness depth of <1 μm.

13. Device according to claim 10, wherein the first rolling body is pressed with the actuating drive against the running surface of the rail with a nominal contact pressure of 1.2 to 1.75 GPa.

14. Device according to claim 7, further comprising:
a second rolling body that is rolled over the rail following the first rolling body to provide cold deformation of the running surface of the rail.

15. Device according to claim 14, wherein the rolling bodies are rolled over the rail with different slip and/or different surface structure and/or different contact pressure.
